(19) United States
(12) Patent Application Publication
(10) Pub. No.: US 2017/0209337 A1
(43) Pub. Date: Jul. 27, 2017

(54) Gesturing Proximity Sensor for Spa Operation

(71) Applicant: SUNDANCE SPAS, INC., Chino, CA (US)

(72) Inventors: Brian Koops, Corona, CA (US); Adrian Alfaro, Menifee, CA (US); John I. Giddens, Corona, CA (US); Bryan D. Gordon, Costa Mesa, CA (US)

(21) Appl. No.: 15/409,932

(22) Filed: Jan. 19, 2017

Related U.S. Application Data
(60) Provisional application No. 62/281,878, filed on Jan. 22, 2016.

(51) Int. Cl. A61H 33/00; G06F 3/01

(52) U.S. Cl. CPC A61H 33/005; G06F 3/017; A61H 33/0087; A61H 33/0095; A61H 2033/0083; A61H 2033/007; A61H 2201/0207; A61H 2201/5007; A61H 2201/5023; A61H 2201/5064

(57) ABSTRACT

A spa can include one or more variable features or functions that can be controlled by a user using a gesture recognition sensor. The gesture recognition sensor can be located proximate to the spa and optionally out of the normal range of motion of a user in a basin of the spa. Predetermined gestures detected by gesture recognition sensor can be interpreted as a command to alter a predetermined feature or function of the spa. Also disclosed is a method of controlling one or more variable features or functions of the spa using the gesture recognition sensor.

### CROSS REFERENCE TO RELATED APPLICATIONS

This application claims the benefit of U.S. Provisional Patent Application No. 62/281,878, filed Jan. 22, 2016, the entire disclosure of which is herein incorporated by reference.

### BACKGROUND OF THE INVENTION

Field of the Invention

The present invention relates to a spa having one or more features or functions controlled by a user using a gesture recognition sensor and a method for controlling the features or functions of the spa using the gesture recognition sensor.

Description of Related Art

Oftentimes, spas include variable features or functions, which are available to enhance a user's experience in the spa. Variable features or functions can include water temperature, water pumps, water jets, lights, a stereo system, or other features or functions. Typically, these variables have been controlled by a main control panel, such as a touchscreen built into the spa tub, or have been controlled remotely by a remote control or smartphone. These electronic means of controlling the variable features or functions of the spa are at risk of getting wet while the spa is in use. This can lead to damage of the exposed control panel, remote control, or smartphone.

The electronic means of controlling the variable features or functions are also sometimes not within reach of the user in a basin of the spa. The main control panel is oftentimes located on a side wall of the spa, out of reach of the user seated in the basin of the spa. Remote means of controlling the spa's variable features or functions are often portable, meaning they can easily be lost or left at a distance from the spa. Therefore, a user wishing to adjust the variable features or functions may need to physically leave the basin of the spa to choose the desired settings. Examples of such spas are shown in U.S. Pat. Nos. 8,644,960 and 7,046,163, which are hereby incorporated by reference.

### SUMMARY OF THE INVENTION

A spa disclosed herein includes a gesture recognition sensor that allows a user to control certain variable features or functions of the spa. The gesture recognition sensor is located within the reach of users in a basin of the spa. The spa may include more than one gesture recognition sensor. The gesture recognition sensor may control water temperature, water pumps, water jets, lights, an audio system, or other variable features or functions. To control a desired variable feature or function, the user gestures proximate the gesture recognition sensor with predetermined motions indicating the feature or function the user wishes to alter.

From the foregoing disclosure and the following description, it will be apparent to those skilled in the art that the present invention provides a significant advance in the technology of spas, including various features or functions controlled by a user using a gesture recognition sensor.

Various preferred and non-limiting examples will now be described as set forth in the following numbered clauses:

Clause 1: A spa comprises: a shell defining a basin for holding water; a plurality of variable features or functions of the spa; a programmed controller configured to control the plurality of variable features or functions; and a gesture recognition sensor operative for generating an electric field and for detecting at least one change in a distribution of electric field lines of the electric field in response to movement of an object in the electric field, wherein the controller is responsive to the gesture recognition sensor detecting said at least one change for controlling a first of the plurality of variable features or functions based on said change.

Clause 2: The spa of clause 1, wherein the change in the distribution of the electric field lines is in response to linear, or rotational, or both linear and rotational movement of the object in the electric field.

Clause 3: The spa of clause 1 or 2, wherein the gesture recognition sensor is operative for detecting a sequence of changes in the distribution of the electric field lines in response to movement of the object in the electric field; and the controller is responsive to the detected sequence of changes in the electric field lines in response to movement of the object in the electric field for controlling the first variable feature or function.

Clause 4: The spa of any one of clauses 1-3, wherein: the gesture recognition sensor is operative for detecting a sequence of changes in the distribution of the electric field lines in response to movement of the object within the electric field; the controller is responsive to a first detected sequence of changes in the electric field lines in response to movement of the object in a first direction in the electric field for controlling the first variable feature or function; and the controller is responsive to a second detected sequence of changes in the electric field lines in response to movement of the object in a second direction in the electric field for controlling a second variable feature or function.

Clause 5: The spa of any one of clauses 1-4, wherein the gesture recognition sensor is disposed proximate to the basin.

Clause 6: The spa of any one of clauses 1-5, wherein the gesture recognition sensor is concealed under the shell.

Clause 7: The spa of any one of clauses 1-6, wherein: at least a portion of the shell is comprised of a material through which the electric field lines of the electric field can pass; and the gesture recognition sensor is concealed under said portion of the shell.

Clause 8: The spa of any one of clauses 1-7, wherein the plurality of variable features or functions of the spa includes at least two of the following: jet temperature; lights high/low/off; light colors; and audio system volume increase/decrease.

Clause 9: A spa control method comprises: (a) providing a gesture recognition sensor operative for generating an electric field and for detecting a change or sequence of changes in a distribution of electric field lines of the electric field in response to movement of an object in the electric field; (b) sensing a first change or a first sequence of changes in the distribution of electric field lines of the electric field in response to a first movement of the object in the electric field; and (c) in response to step (b), controlling a first variable feature or function of the spa.

Clause 10: The method of clause 9, further comprising: (d) sensing a second change or a second sequence of changes in the distribution of electric field lines of the electric field in response to a second movement of the object in the electric field, wherein the second movement of the object in the electric field is different than the first movement of the object in the electric field; and (e) in response to step (d), controlling a second variable feature or function of the spa.

Clause 11: A spa control method comprising: (a) a gesture recognition sensor detecting a first predetermined set of changes in a distribution of electric field lines of an electric field generated by the gesture recognition sensor in response to an object performing a first predetermined gesture in the electric field; and (b) adjusting a first variable feature or function of the spa related to the first predetermined set of changes in the distribution of electric field lines detected in step (a).

Clause 12: The method of clause 11, further comprising: (c) the gesture recognition sensor detecting a second predetermined set of changes in the distribution of electric field lines of the electric field generated by the gesture recognition sensor in response to an object performing a second, different predetermined gesture in the electric field; and (d) adjusting a second variable feature or function of the spa related to the second predetermined set of changes in the distribution of electric field lines detected in step (c).

Clause 13: The method of clause 11 or 12, wherein each predetermined gesture comprises a unique set of at least two connected motions of the object in two- or three-dimensions.

Clause 14: The method of any one of clauses 11-13, wherein each motion comprises at least one of the following movements in two- or three-dimensions: a straight line, a serpentine line, a curved line, an arc, and a whole or partial circle.

### BRIEF DESCRIPTION OF THE DRAWINGS

FIG. 1 shows a perspective view of an example spa;

FIG. 2 shows a plan view of the spa of FIG. 1;

FIG. 3A is a perspective view of an example gesture recognition sensor;

FIG. 3B is a block diagram of a spa controller connected between the gesture recognition sensor of FIG. 3A and a number of example features or functions of the spa that can be controlled by the controller in response to a gesture proximate to the gesture recognition sensor;

FIGS. 4A-4C are views taken along lines IV-IV and FIG. 3, wherein FIG. 4A illustrates undistorted electric field lines and FIGS. 4B and 4C show different distorted electric field lines;

FIG. 5 shows a plan view of the gesture recognition sensor of FIG. 3 with a hand making a gesture;

FIG. 6 shows a side view of the gesture recognition sensor of FIG. 3 with a hand making a gesture;

FIG. 7A is a flow diagram of a method by which a user controls a variable feature or function of a spa based on a user gesture; and

FIG. 7B is a flow diagram of a method by which a spa adjusts a variable feature or function based on a user gesture.

### DESCRIPTION OF THE INVENTION

It will be apparent to those skilled in the art that many uses and design variations are possible for the spa disclosed herein. The following examples will illustrate general principles, but other examples and variations will be apparent to those skilled in the art given the benefit of this disclosure.

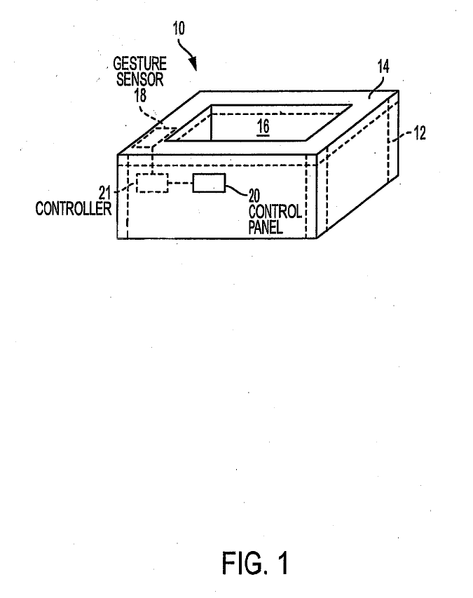

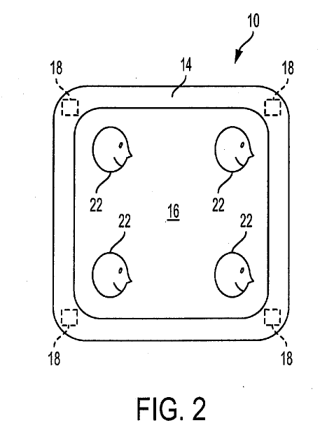

Referring to FIGS. 1-2, in an example, a spa 10 can include a frame 12, a shell 14, and a basin 16. The frame 12 of the spa 10 is the skeleton of the spa 10 and outlines the basic shape of the spa 10. The shell 14 can cover at least a portion of the frame 12 and can give the spa 10 a more finished appearance. The basin 16 can be defined by the shell 14 of the spa 10 and is a cavity configured to receive and retain water.

The spa 10 can also include a gesture recognition sensor 18, and the spa 10 may also include a conventional control panel 20. A controller 21 for controlling various features of functions of spa 10, e.g., automatically and/or in response to an output of gesture recognition sensor 18, control panel 20, or both, in response to user input can be provided as a separate unit, as part of gesture recognition sensor 18, as part of a control panel 20, or any combination thereof.

Gesture recognition is a growing field in the area of human-machine interaction. Gesture recognition allows users to interact with computers, machines, or devices by making movements of the hand, arm, face, or body, for instance. Traditionally, gesture recognition has involved a physical interaction between the user and a mechanical device. Examples of such mechanical devices include a mouse, stylus, sensor glove, or touchscreen. However, recent gesture recognition technology can be based on touchless sensing using cameras, ultrasonics, infrared light, radar, or electric near-field sensing.

Gesture recognition sensor 18 can be located anywhere on the spa 10. Spa 10 may include more than one gesture recognition sensor 18 (see FIG. 2) located at any suitable and/or desirable locations. In an example, each gesture recognition sensor 18 can be located proximate to the basin 16 of the spa 10. Proximate means within reach of a user 22 seated in the basin 16 of the spa 10. In an example, the gesture recognition sensor 18 can be located outside of the normal range of movement of users 22 in the basin 16 of the spa 10. This prevents false triggering of the gesture recognition sensor 18 due to movement of a user 22 in the spa 10. Thus, in an example, the gesture recognition sensor 18 can be located proximate to the basin 16 but outside the normal range of movement of user 22 in the basin 16 of the spa 10. Further, in an example, the gesture recognition sensor 18 can be located above a waterline within the basin 16.

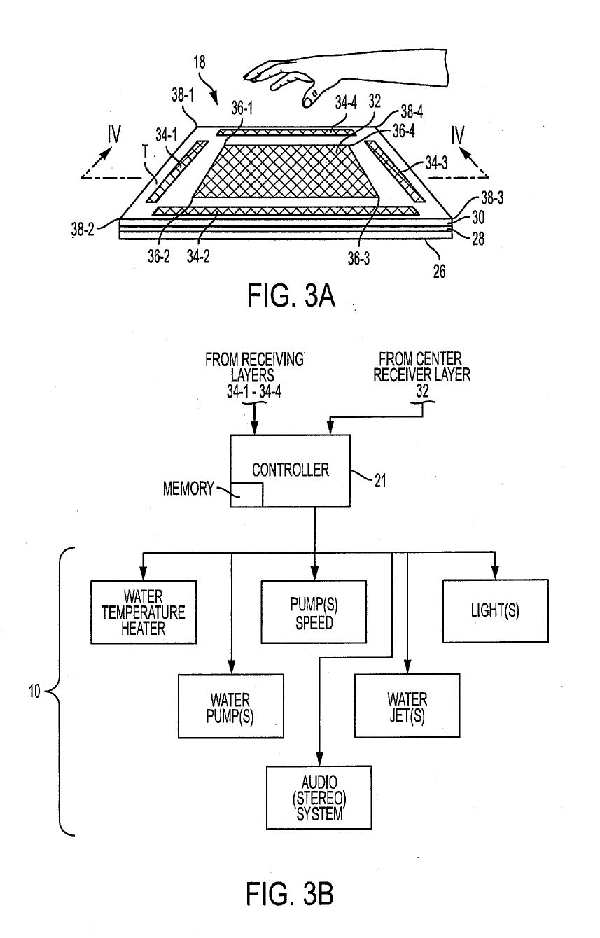

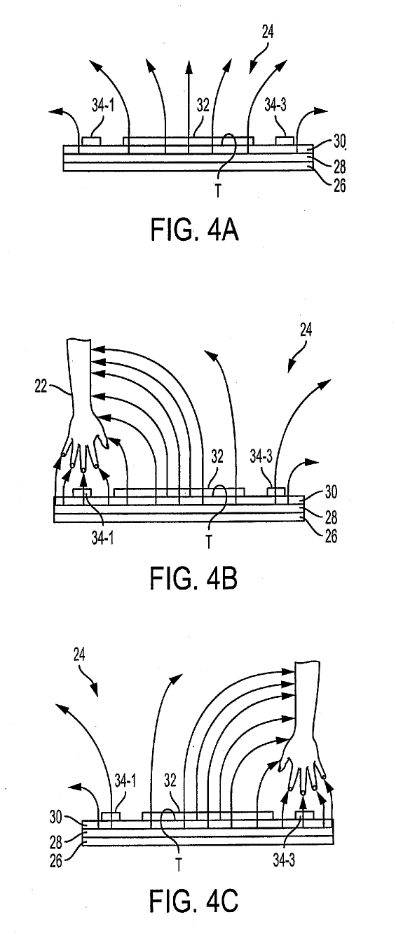

Any suitable technology may be employed for the gesture recognition sensor 18. Non-limiting examples of suitable technologies include touchless sensing using cameras, ultrasonics, infrared light, radar, or electric near-field sensing. Whether the gesture recognition sensor 18 is exposed to the environment or concealed may depend on the technology used to sense gestures. In an example described herein, the gesture recognition sensor 18 utilizes electric near-field sensing technology (as shown in FIGS. 3A-4B). Electric near-field sensing allows the gesture recognition sensor 18 to be concealed, with no visible or obvious means of sensing. With electric near-field sensing, the gesture recognition sensor 18 can be hidden beneath, and therefore protected by, an enclosure or covering made of materials that do not or minimally affect the properties of electric fields, such as, for example, shell 14 made of non-metallic material. In an example of a spa 10 utilizing this technology, the gesture recognition sensor 18 can be located beneath the shell 14, and the shell 14 can be made of any non-metallic material(s) that do not or minimally affect the distribution of electric fields that is/are also suitable to protect the gesture recognition sensor 18. Use of electric near-field sensing requires no stylus or wearable device.

The gesture recognition sensor 18 can be exposed to the environment or concealed. In an example, the gesture recognition sensor 18 can be located proximate to the basin 16 and concealed under the shell 14 above the waterline within the basin 16. Concealing the gesture recognition sensor 18 under the shell 14 allows the spa 10 to maintain a more appealing design, while still benefiting from the functionality of the gesture recognition sensor 18, as well as protecting the gesture recognition sensor 18 from environmental conditions. In other words, in this example, no part of the gesture recognition sensor 18 is visible or obvious because the gesture recognition sensor 18 is concealed.

Where gesture recognition sensor 18 is concealed under the shell 14, the exterior surface of the shell 14 above the gesture recognition sensor 18 can include a suitable marking that enables a user 22 to identify where to gesture such that gesture recognition sensor 18 detects said gesture. This marking can include, without limitation, any one or more of the following: a visual impression on the surface, such as a line, spot, indentation, discoloration, or symbol that is either applied to said surface or formed in said surface. However, this is not to be construed in a limiting sense since it is envisioned that said surface can, alternatively, not include any mark. Rather, the position of gesture recognition sensor 18 can be known from other physical features of the shell 14, e.g., the gesture recognition system can be concealed under a rail or side of the shell 14 adjacent a corner of the shell 14.

In an example, the shell 14 can be made of a material (for example, a polymer) that has little or no effect on an electric field 24 generated by gesture recognition sensor 18 when the gesture recognition sensor 18 is placed on an underside of shell 14. In an example, the shell 14 can be primarily acrylic. Glass reinforced polyester and vinyl ester resins can be included to add strength.

In another example, gesture recognition sensor 18 can be placed on an upper surface of the shell 14 and covered by a suitable water resistant/proof covering so that it can be adequately protected from water, heat, and humidity. In another example, the gesture recognition sensor 18 can co-act with the spa shell 14. For example, the gesture recognition sensor 18 can be recessed in an exposed surface of shell 14 or in a recess in a hidden surface of the shell 14.

One or more features or functions of spa 10 can be controlled by gesture recognition sensor 18. For example, in response detecting a gesture within its electric field 24, gesture recognition sensor 18 can output a set or series of signals. This set or series of signals can be digital signals or analog signals. In the case where the set or series of signals are digital signals, these digital signals can be processed by controller 21 directly. On the other hand, a set or series of analog signals output by gesture recognition sensor 18 can be converted into corresponding digital signals either by an analog-to-digital converter of controller 21 or before reaching controller 21, e.g., by a suitable analog-to-digital converter in the signal path between the output of gesture recognition sensor 18 and a corresponding digital input of controller 21.

In an example, the memory of controller 21 can store one or more predetermined sets or sequences of digital signals corresponding to predetermined gestures occurring within the electric field 24 of gesture recognition sensor 18. Thus, upon acquiring a set or series of digital signals in response to an actual gesture occurring within the electric field 24 of gesture recognition sensor 18, controller 21 can search for a match between the acquired set or series of digital signals and at least one of the predetermined set or sequence of digital signals stored in the memory of controller 21. Upon detecting a match, albeit an exact match or an approximate match within a predefined tolerance, controller 21 can perform one or more corresponding features or functions of the spa 10.

Features or functions of the spa 10 that can be controlled by controller 21 in response to gesture recognition sensor 18 detecting a gesture within its electric field 24 can include, but is not limited to, for example: increase or decrease water temperature; changing the on/off state(s) and/or speed(s) of one or more water pump(s); changing the on/off state(s) and/or dimmer state of one or more lights; and/or changing one or more of the on/off state, volume, equalization, e.g., bass/treble control, radio station selection, song selection, and the like of an audio system.

Using gestures, the user 22 via gesture recognition sensor 18 can toggle features of the spa on or off or set an output level of a feature, such as light intensity or audio system volume, to a value between on and off. In another example, the gesture recognition sensor 18 can be used to adjust the water temperature up or down or may be used to turn water jets on or off. Additionally, via the gesture recognition sensor 18, gestures can be used to cycle a feature through discrete settings, such as selecting a lighting pattern or lighting color.

Controller 21 can be any suitable and/or desirable controller that can perform the features and functions normally associated with a spa 10 and the features and functions described herein. In an example, controller 21 can include a microprocessor, computer memory, and any related hardware and/or software modules required for its operation.

With continuing reference to FIG. 1, the spa 10 control panel 20 can be configured to adjust one, or more, or all of the features or functions that are also adjustable using the gesture recognition sensor 18. In other words, in spas 10 that include a control panel 20 and a gesture recognition sensor 18, the latter of which can be configured to perform one, or more, or all of the same functions that can be performed via the control panel 20. In an example, the location of the gesture recognition sensor 18 can be remote from the control panel 20. The control panel 20 can be a touchscreen or utilize any technology suitable for control panels 20 of spas 10.

FIG. 3A shows a perspective view of a non-limiting example gesture recognition sensor 18 that includes a ground layer 26, an electric-field transmit layer 28, and an isolation layer 30. A top side (T) of isolation layer 30 opposite transmit layer 28 includes a center receiver layer 32 which, in this example, can be surrounded by a plurality of lateral receiver layers 34-1-34-4. In an example, ground layer 26 and electric-field transmit layer 28 can be electrically isolated from each other, e.g., via an insulator disposed between ground layer 26 and electric-field transmit layer 28. In an example, isolation layer 30 can be made from electrical insulating material that electrically isolates center receiver layer 32 and lateral receiver layers 34-1-34-4 from each other and from transmit layer 28. In an example, center receiver layer 32 can be rectangular or square, and one lateral receiver layer 34-1-34-4 can be positioned along each side of center receiver layer 32 between said side and the perimeter of isolation layer 30.

FIG. 3B shows the connections of center receiver layer 32 and lateral receiver (or receiving) layers 34-1-34-4 to controller 21 which in turn can be connected to control one or more features or functions of spa 10, such as, without limitation: water temperature heater, pump(s), light(s), water pump(s), water jet(s), and/or audio (stereo) system. The features or functions of spa 10 shown in FIG. 3B are exemplary only and are not to be construed in a limiting sense.

The operation of the gesture recognition sensor 18 shown in FIG. 3A, will now be described with reference to FIGS. 4A-4C.

Referring to FIG. 4A and with continuing reference to FIG. 3A, in response to an external voltage applied to transmit layer 28, transmit layer 28 generates electric field (equal potential) lines 24 that are undistorted. These electric field lines 24 can be produced by applying a suitable voltage to transmit layer 28. In an example, the applied voltage can be an AC voltage having a frequency in the range of about 100 kHz, which causes electrical charges to be spread three-dimensionally about the upper surface of transmit layer 28 which, in turn, produces electric field lines 24. In another example, a DC voltage can be applied to transmit layer 28 to produce electric field lines 24. However, in practice, an AC voltage is more desirable because it suppresses magnetic components to practically zero whereupon little or no magnetic field propagation takes place.

As shown in FIG. 4B, in response to a user 22 entering the space above lateral receiver layer 34-1, the distribution of the electric field lines 24 becomes distorted, whereupon electric field lines intercepted by the user 22 are shunted to ground through the conductivity of the user's 22 body itself. More specifically, as shown in FIG. 4B, the proximity of the user 22 above lateral receiver layer 34-1 causes a compression of the electric field (equal potential) lines 24 and shifts lateral receiver layer 34-1 to a lower potential, e.g., near to or closer to ground potential, which can be detected by controller 21.

Similarly, as shown in FIG. 4C, if the user's 22 hand is positioned above lateral receiver layer 34-3, the proximity of the user's 22 hand to lateral receiver layer 34-3 causes a compression of the electric field (equal potential) lines 24 and shifts the lateral receiver layer 34-1 to a lower potential, which can be detected by controller 21.

As would be understood by one skilled in the art, center receiver layer 32 and the plurality of lateral receiver layers 34-1-34-4 surrounding center receiver layer 32 enables gesture recognition sensor 18 to accurately detect the position of the user 22 (e.g., the user's hand or fingers) at various positions above top surface (T) of gesture recognition sensor 18 with a sufficient degree of discrimination that enables gesture recognition sensor 18 to be utilized to control one or more features or functions of spa 10.

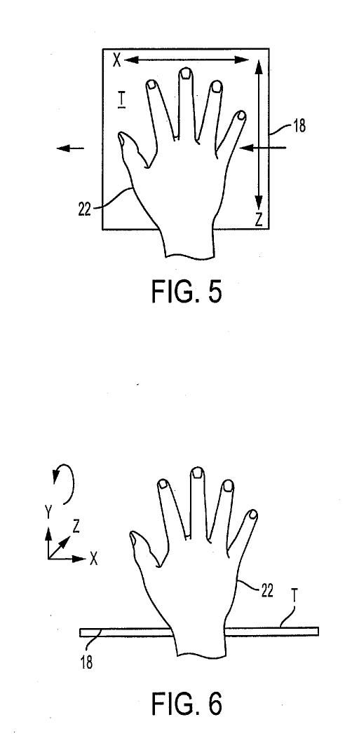

In an example, controller 21 can be programmed such that when the user's 22 hand moves from right to left (see FIG. 5) in the electric field 24 over gesture recognition sensor 18 in FIG. 3A, that is the user's 22 hand moves in sequence over lateral receiver layer 34-3, then over center receiver layer 32, and then finally over lateral receiver layer 34-1, such movement can be interpreted by controller 21 as a command to, for example, toggle a jet pump on. Similarly, a reverse gesture, namely, the user's 22 hand moving from left to right over lateral receiver layer 34-1, then over center receiver layer 32, and finally over lateral receiver layer 34-3 can be interpreted by controller 21 as a command to, for example, toggle the jet pump off. The toggling of jet pump on/off in this example is not to be construed in a limiting sense since it is envisioned that any function or feature of spa 10 can be controlled by a user's hand moving right to left, or vice versa, in the electric field 24.

In another example, the user's 22 hand moving in sequence over lateral receiver layer 34-2, then over center receiver layer 32, and finally over lateral receiver layer 34-4 can be interpreted by controller 21 as a command to cycle light power settings from high, to low, to off. For example, a first instance of user's hand 22 moving in sequence over receiver layers 34-2, then 32, and finally 34-4 can cycle the light power settings from off to high. A second instance of this movement can cycle the light power settings from high to low, while a third instance of this movement can cycle the power from low to off. However, this is not to be construed in a limiting sense.

In another example, a reverse gesture, namely, the user's 22 hand moving in sequence over lateral receiver layer 34-4, then over center receiver layer 32, and finally over lateral receiver layer 34-1 can be interpreted by controller 21 as a command to cycle the color of the lights, e.g., from red, to green, to blue, etc. For example, a first instance of the user's hand moving in sequence over layers 34-2, then 32, and finally 34-1 can cause the color of the lights to change from white to red, a second instance of this movement can cause the light color to change from red to green, a third instance of this movement can cause the lights to change from green to blue, and a fourth instance of this movement can cause the lights to change from blue to white. However, this is not to be construed in a limiting sense.

In another example, the user's 22 hand moving fully or partially clockwise (CW) (as viewed looking downward on top surface (T) of gesture recognition sensor 18), can be interpreted by controller 21 as a command to increase the volume of the audio system. In contrast, a full or partial counterclockwise (CCW) gesture of the user's 22 hand above top surface (T) can be interpreted by controller 21 as a command to decrease the volume.

The foregoing examples of controller 21 responding to certain gestures above top surface (T) of gesture recognition sensor 18 are examples only and are not to be construed in a limiting sense. To this end, it is envisioned that one of ordinary skill in the art can program controller 21 to respond to any number or types of gestures within electric field 24 and within the discriminating capability of gesture recognition sensor 18.

With continued reference to FIGS. 3A and 4A-4C, in general, electric near-field sensing works by gesture recognition sensor 18 generating an electric field lines 24 above the gesture recognition sensor 18. FIG. 4A shows the electric field (equal potential) lines 24 of an undistorted electric field generated by the gesture recognition sensor 18. FIGS. 4B and 4C show the electric field lines 24 of the distorted electric field generated by the gesture recognition sensor 18 caused by at least a part of the user 22 entering the electric field. The generated electric field lines 24 can be used for sensing conductive objects, such as human body parts (e.g., hand, arm, foot, etc.). The generated electric field lines 24 can sense the user 22, for instance, when the user 22 enters the electric field lines 24, which then becomes distorted, and the proximity of the user 22 causes the electric field equipotential lines to compress. Thus, using this technology, the user's 22 motions can be detected.

Referring to FIGS. 5-6, the gesture recognition sensor 18 uses electric near-field sensing to adjust variable features or functions of the spa 10 by sensing the motion of the user 22. FIGS. 5 and 6 show the gesture recognition sensor 18 detecting the motion of the user's 22 hand, but other body parts, or conductive objects may be used by the user 22 to control the various features or functions of the spa 10.

FIG. 5 shows another top view of the gesture recognition sensor 18 detecting the hand of the user 22. For example, the user's 22 hand can move in an x-direction or z-direction over the gesture recognition sensor 18. The hand can also move in the y-direction as shown in FIG. 6. Controller 21 can be programmed to detect the output of gesture recognition sensor 18 in response to user 22 motions above top surface (T) of gesture recognition sensor 18 in the electric field equipotential linesthereof. This includes movement in only one direction (i.e., the x-direction, y-direction, and/or z-direction). This also includes movement in multiple directions simultaneously (e.g., the x-direction, y-direction, and z-direction), or in an arc or curve, or in combinations of linear and curved motions. Thus, the gesture recognition sensor 18 can also sense complex movements, such as arcs or rotational movement of a user's 22 hand or a waving of the user's 22 hand in multiple directions. The description herein of various motions of the user's 22 hand that can be detected by the gesture recognition sensor 18, however, is not to be construed in a limiting sense since it is envisioned that any movement that can be detected and discriminated by gesture recognition sensor 18 can be used by controller 21 for controlling a function of the spa.

In another example, gesture recognition sensor 18 can recognize a “TOUCH” function, where the user 22 taps with a single finger one or more times on top surface (T). A user 22 may also perform an “EDGE FLICK” function where the user 22 partially enters the electric field lines 24, but does not pass all the way through the electric field 24, e.g., entering the electric field lines 24 above top surface (T) of gesture recognition sensor 18.

Multiple features or functions of the spa 10 can be varied using the same gesture recognition sensor 18. A single gesture recognition sensor 18 can control multiple features or functions of the spa 10 by assigning predetermined gestures as commands for desired changes in predetermined features or functions. In an example, a first gesture detected by the gesture recognition sensor 18 may indicate to the controller 21 that the user 22 wishes to increase or decrease the water temperature, while a second gesture detected by the gesture recognition sensor 18 may signal that the user 22 wishes to turn on the audio system. A different gesture may be assigned to each of one, or more, or all of the variable features or functions of spa 10 controlled by the gesture recognition sensor 18 to allow the user 22 seated in the basin 16 to control the spa 10. Once the gesture recognition sensor 18 identifies a predetermined motion or gesture by the user 22, the controller 21 can effect the change in the feature or function associated with that predetermined motion or gesture.

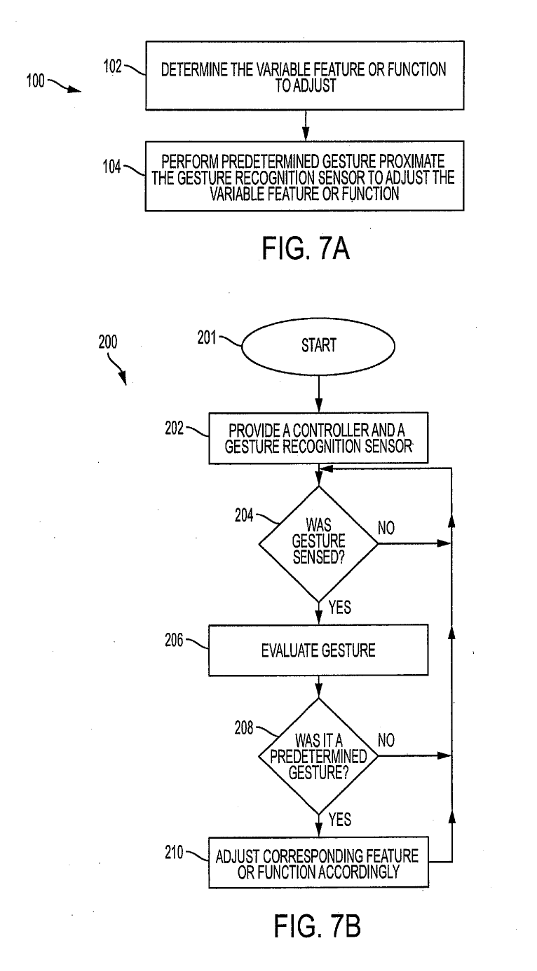

FIGS. 7A-7B, show example methods for controlling spa 10. FIG. 7A shows an example method 100 by which a user can adjust one or more of the variable features or functions of spa 10. In step 102 of process 100, the user determines which variable feature or function the user wishes to adjust. Then, in step 104, the user performs a predetermined gesture that corresponds to adjusting the desired feature or function proximate the gesture recognition sensor 18 (i.e., in the electric field lines 24 of gesture recognition sensor 18), in order to instruct controller 21 to adjust the variable feature or function 104.

FIG. 7B shows an example method 200 by which variable features or functions of the spa 10 are adjusted. Initially, the method advances from Start step 201 to step 202, wherein controller 21 and gesture recognition sensor 18 are provided. Controller 21 can be configured to adjust at least one variable feature or function of spa 10. The method then advances to step 204, wherein gesture recognition sensor 18 can be active to determine whether a gesture is sensed. If a gesture is sensed, the method advances to step 206, wherein controller 21 evaluates (or otherwise processes) the sensed gesture 206. In step 208, controller 21 determines if the gesture evaluated in step 206 matches, albeit an exact match or an approximate match within a predefined tolerance, a predetermined gesture stored or preprogrammed into the memory of controller 21. If, in step 208, it is determined that the gesture evaluated in step 206 is not a predetermined gesture, the sensed gesture can be disregarded and the method returns to step 204 to sense for a subsequent gesture. If in step 208, however, controller 21 determines the sensed gesture evaluated in step 206 matches, albeit an exact match or an approximate match within a predefined tolerance, a predetermined gesture 208 stored or preprogrammed into the memory of controller 21, the method advances to step 210 wherein controller 21 adjusts the corresponding feature or function of spa 10 accordingly. The method then returns to step 204 to sense for a subsequent gesture. Steps 204-210 can be repeated any number of times for each gesture sensed by gesture recognition sensor 18.

While various examples have discussed spa 10 including gesture recognition sensor 18 to control various features or functions, it is also contemplated that the spa 10 may instead be, more generally, a water holding vessel. For instance, in an example, it is envisioned that spa 10 can be replaced by a bath tub or a swimming pool that includes a gesture recognition sensor 18 to control various features or functions.

The examples have been described with reference to the various figures. Modifications and alterations will occur to others upon reading and understanding the foregoing examples. Accordingly, the foregoing examples are not to be construed as limiting this disclosure.

The invention claimed is:

1. A spa comprising:
a shell defining a basin for holding water;
a plurality of variable features or functions of the spa;
a programmed controller configured to control the plurality of variable features or functions; and
a gesture recognition sensor operative for generating an electric field and for detecting at least one change in a distribution of electric field lines of the electric field in response to movement of an object in the electric field, wherein the controller is responsive to the gesture recognition sensor detecting said at least one change for controlling a first of the plurality of variable features or functions based on said change.

2. The spa of claim 1, wherein the change in the distribution of the electric field lines is in response to linear, or rotational, or both linear and rotational movement of the object in the electric field.

3. The spa of claim 1, wherein:
the gesture recognition sensor is operative for detecting a sequence of changes in the distribution of the electric field lines in response to movement of the object in the electric field; and
the controller is responsive to the detected sequence of changes in the electric field lines in response to movement of the object in the electric field for controlling the first variable feature or function.

4. The spa of claim 1, wherein:
the gesture recognition sensor is operative for detecting a sequence of changes in the distribution of the electric field lines in response to movement of the object within the electric field;
the controller is responsive to a first detected sequence of changes in the electric field lines in response to movement of the object in a first direction in the electric field for controlling the first variable feature or function; and
the controller is responsive to a second detected sequence of changes in the electric field lines in response to movement of the object in a second direction in the electric field for controlling a second variable feature or function.

5. The spa of claim 1, wherein the gesture recognition sensor is disposed proximate to the basin.

6. The spa of claim 1, wherein the gesture recognition sensor is concealed under the shell.

7. The spa of claim 6, wherein:
at least a portion of the shell is comprised of a material through which the electric field lines of the electric field can pass; and
the gesture recognition sensor is concealed under said portion of the shell.

8. The spa of claim 1, wherein the plurality of variable features or functions of the spa includes at least two of the following: jet temperature; lights high/low/off; light colors; and
audio system volume increase/decrease.

9. A spa control method comprising:
(a) providing a gesture recognition sensor operative for generating an electric field and for detecting a change or sequence of changes in a distribution of electric field lines of the electric field in response to movement of an object in the electric field;
(b) sensing a first change or a first sequence of changes in the distribution of electric field lines of the electric field in response to a first movement of the object in the electric field; and
(c) in response to step (b), controlling a first variable feature or function of the spa.

10. The method of claim 9, further comprising:
(d) sensing a second change or a second sequence of changes in the distribution of electric field lines of the electric field in response to a second movement of the object in the electric field, wherein the second movement of the object in the electric field is different than the first movement of the object in the electric field; and
(e) in response to step (d), controlling a second variable feature or function of the spa.

11. A spa control method comprising:
(a) a gesture recognition sensor detecting a first predetermined set of changes in a distribution of electric field lines of an electric field generated by the gesture recognition sensor in response to an object performing a first predetermined gesture in the electric field; and
(b) adjusting a first variable feature or function of the spa related to the first predetermined set of changes in the distribution of electric field lines detected in step (a).

12. The method of claim 11, further comprising:
(c) the gesture recognition sensor detecting a second predetermined set of changes in the distribution of electric field lines of the electric field generated by the gesture recognition sensor in response to an object performing a second, different predetermined gesture in the electric field; and
(d) adjusting a second variable feature or function of the spa related to the second predetermined set of changes in the distribution of electric field lines detected in step (c).

13. The method of claim 11, wherein each predetermined gesture comprises a unique set of at least two connected motions of the object in two- or three-dimensions.

14. The method of claim 13, wherein each motion comprises at least one of the following movements in two- or three-dimensions: a straight line, a serpentine line, a curved line, an arc, and a whole or partial circle.
